(19) United States
(12) Patent Application Publication
(10) Pub. No.: US 2012/0052407 A1
(43) Pub. Date: Mar. 1, 2012

(54) PROCESSES FOR PREPARING STABLE PROTON EXCHANGE MEMBRANES AND CATALYST FOR USE THEREIN

(75) Inventors: Kimberly Gheysen Raiford, Hockessin, DE (US); Dennis Edward Curtin, Fayetteville, NC (US); Kostantinos Kourtakis, Media, PA (US)

(73) Assignee: E. I. DU PONT DE NEMOURS AND COMPANY, Wilmington, DE (US)

(21) Appl. No.: 13/291,748

(22) Filed: Nov. 8, 2011

Related U.S. Application Data
(62) Division of application No. 11/038,897, filed on Jan. 18, 2005.
(60) Provisional application No. 60/537,534, filed on Jan. 20, 2004.

(51) Int. Cl. H01M 8/04; H01M 8/00

(52) U.S. Cl. 429/428; 429/535

(57) ABSTRACT

The present invention relates to a process for increasing an ion exchange membrane's resistance to peroxide radical attack in a fuel cell environment comprising the use of catalytically active components capable of decomposing hydrogen peroxide as well as a method for preparing a catalytically active component for use therein. Thus, a process has been developed for reducing or preventing proton exchange membrane degradation due to its interaction with hydrogen peroxide, where the catalytically active components serve as hydrogen peroxide scavengers to protect the PEM from chemical reaction with hydrogen peroxide by decomposing the hydrogen peroxide to H₂O and O₂ rather than the radicals that degrade the PEM.

### FIELD OF THE INVENTION

The present invention relates to a process for increasing an ion exchange membrane's resistance to peroxide radical attack in a fuel cell environment comprising the use of catalytically active components capable of decomposing hydrogen peroxide, thereby providing a more stable proton exchange membrane, as well as a method for preparing a catalytically active component for use therein.

### BACKGROUND

Electrochemical cells generally include an anode electrode and a cathode electrode separated by an electrolyte, where a proton exchange membrane (hereafter “PEM”) is used as the electrolyte. A metal catalyst and electrolyte mixture is generally used to form the anode and cathode electrodes. A well-known use of electrochemical cells is in a stack for a fuel cell (a cell that converts fuel and oxidants to electrical energy). In such a cell, a reactant or reducing fluid such as hydrogen is supplied to the anode, and an oxidant such as oxygen or air is supplied to the cathode. The hydrogen electrochemically reacts at a surface of the anode to produce hydrogen ions and electrons. The electrons are conducted to an external load circuit and then returned to the cathode, while hydrogen ions transfer through the electrolyte to the cathode, where they react with the oxidant and electrons to produce water and release thermal energy. An individual fuel cell consists of a number of functional components aligned in layers as follows: conductive plate/gas diffusion backing/anode electrode/membrane/cathode electrode/gas diffusion backing/conductive plate.

Long term stability of the proton exchange membrane is critically important for several industrial applications, such as fuels cells. For example, the lifetime goal for stationary fuel cell applications is 40,000 hours of operation. Typical membranes found in use throughout the art will degrade over time through decomposition and subsequent dissolution of the fluoropolymer, thereby compromising membrane viability and performance. While not wishing to be bound by theory, it is believed that this degradation is a result of the reaction of the membrane fluoropolymer with hydrogen peroxide (H₂O₂) radicals, which are generated during fuel cell operation.

Thus, it is desirable to develop a process for reducing or preventing proton exchange membrane degradation due to its interaction with hydrogen peroxide radicals, thereby sustaining its level of performance while remaining stable and viable for longer periods of time, wherein as a result, fuel cell costs could be reduced.

### SUMMARY OF THE INVENTION

The present invention relates to a process for increasing peroxide radical resistance (a.k.a. increasing the oxidative stability of the ion exchange membrane or decreasing polymer exchange membrane degradation) in a fuel cell perfluorosulfonic acid ion exchange membrane comprising: a) forming a perfluorosulfonic acid ion exchange membrane with a catalytically active component therein, the membrane having a thickness of about 127 microns or less; b) fabricating the membrane into a membrane electrode assembly and incorporating the assembly into a fuel cell; c) operating the fuel cell wherein at least one hydrogen peroxide molecule is generated; d) contacting the at least one hydrogen peroxide molecule with the catalytically active component; and e) decomposing the hydrogen peroxide molecule to form water and oxygen.

The catalytically active component precursors used for treating the PEM comprise at least one of metals (e.g. Ag, Pd, and Ru and combinations thereof), metal salts (e.g. salts of Ag, Ru or Pd) and oxygen containing complexes (e.g. Ti—O containing species, zirconium oxide, Zr—O containing species, niobium oxide, Nb—O containing species, ruthenium oxide, and Ru—O containing species).

The present invention also relates to a process for incorporating at least one alkoxide into a perfluorosulfonic acid ion exchange membrane, where the process comprises: (i) preparing an ion exchange membrane by extracting water from the ion exchange membrane; (ii) optionally drying the ion exchange membrane; (iii) imbibing the ion exchange membrane with the at least one alkoxide; and (iv) slow hydrolysis in air.

The present invention further relates to a metallized ion exchange membrane and electrochemical devices comprising the metallized ion exchange membrane, wherein the ion exchange membrane is stabilized according to the present invention.

Other methods, features and advantages of the present invention will be or become apparent to one with skill in the art upon examination of the following detailed description. It is intended that all such additional methods, features and advantages be included within this description and within the scope of the present invention.

### DETAILED DESCRIPTION

Where a range of numerical values is recited herein, unless otherwise stated, the range is intended to include the endpoints thereof, and all integers and fractions within the range. It is not intended that the scope of the invention be limited to the specific values recited when defining a range. Moreover, all ranges set forth herein are intended to include not only the particular ranges specifically described, but also any combination of values therein, including the minimum and maximum values recited.

Fuel cells are electrochemical devices that convert the chemical energy of a fuel, such as a hydrogen gas, and an oxidant into electrical energy. Typical fuel cells comprise an anode (a negatively charged electrode), a cathode (a positively charged electrode) separated by an electrolyte that are formed as stacks or assemblages of membrane electrode assemblies (MEA). Fuel cells generally comprise a catalyst coated membrane (CCM) in combination with a gas diffusion backing (GDB) to form an unconsolidated membrane electrode assembly (MEA). The catalyst coated membrane comprises an ion exchange polymer membrane and catalyst layers or electrodes formed from an electrocatalyst coating composition.

The present invention is intended for use in conjunction with fuel cells utilizing proton-exchange membranes (also known as “PEM”). Examples include hydrogen fuel cells, reformed-hydrogen fuel cells, direct methanol fuel cells or other liquid feed fuel cells (e.g. those utilizing feed fuels of ethanol, propanol, dimethyl- or diethyl ethers), formic acid, carboxylic acid systems such as acetic acid, and the like.

As used herein, “catalytically active” shall mean a component having the ability to serve as a hydrogen peroxide scavenger to protect the PEM from chemical reaction with hydrogen peroxide by decomposing the hydrogen peroxide to 2H₂O and O₂

As noted above, and while not wishing to be bound by theory, it is believed that degradation of the PEM is a result of the reaction of the membrane fluoropolymer with hydrogen peroxide radicals, which are generated during fuel cell operation.

It is believed that the process for synthesizing the alkoxide catalytically active precursor components and mixtures thereof according to the present invention plays a role in generating the correct microstructure and oxide or oxyhydroxide phases needed for hydrogen peroxide scavenging.

The present invention contemplates a process for increasing peroxide radical resistance (a.k.a. increasing the oxidative stability of the ion exchange membrane or decreasing polymer exchange membrane degradation) in a fuel cell perfluorosulfonic acid ion exchange membrane comprising:
a) forming a perfluorosulfonic acid ion exchange membrane with a catalytically active component therein, the membrane having a thickness of about 127 microns or less;
b) fabricating the membrane into a membrane electrode assembly and incorporating the assembly into a fuel cell;
c) operating the fuel cell wherein at least one hydrogen peroxide molecule is generated;
d) contacting the at least one hydrogen peroxide molecule with the catalytically active component; and
e) decomposing the hydrogen peroxide molecule to form water and oxygen.

The present invention serves to promote the long term stability of the proton exchange membrane for use in fuels cells. Typical perfluorosulfonic acid ion exchange membranes found in use throughout the art will degrade over time through decomposition and subsequent dissolution of the fluoropolymer, thereby compromising membrane viability and performance. However, the present invention provides for a membrane having a long term stability, targeting durability goals of up to about 8,000 hours in automotive applications and up to about 40,000 hours for stationary applications.

### Catalytically Active Component

In general, the catalytically active components of the present invention are delivered to the interior of the ion exchange membrane or the surface of a gas diffusion backing (anode or cathode). The catalytically active components may additionally be provided to other locations such as to the surface of the ion exchange membrane or to the electrocatalyst. In some cases these precursors, where upon being appropriately positioned, are completely or partly chemically reduced using hydrazine, hypophosphorous acid, hydroxylamine, borohydride, and possibly hydrogen gas (for gas diffusion electrodes) and other reducing agents known within the art to generate the activated catalytic component. In other cases, alkoxide precursors that are delivered to the interior of the membrane, surface of the membrane, gas diffusion backing, or in the electrocatalyst layer, can be hydrolyzed with water (either present in the air or added as a reagent) to form the appropriate oxygen containing catalytically active component. Addition of acids such as sulfuric or phosphoric acids during the hydrolysis of the alkoxides can generate sulfates and phosphates as well as oxysulfates, oxyphosphates and mixtures thereof, the aforementioned mixtures with oxides, oxyhydroxides and other oxygen containing species.

The catalytically active component precursors used for treating the PEM comprise at least one of metals, metal salts and oxygen containing complexes. Non-limiting examples of metals include Ag, Pd, and Ru and combinations thereof. Non-limiting examples of metal oxides include at least one of titanium oxide or Ti—O containing complexes (prepared in a specific fashion as set forth below and in Example 4) such as, for example, titanium oxysulfates and titanium oxyphosphates, zirconium oxide or Zr—O containing complexes such as, for example, zirconium oxysulfates and sulfated zirconia, niobium oxide or Nb—O containing complexes such as, for example, niobium oxysulfates, and ruthenium oxide or Ru—O containing complexes such as hydrated ruthenium oxide, ruthenium oxyhydroxide or ruthenium oxysulfate. The inorganic metal alkoxides used in conjunction with the present invention include any alkoxide having from 1 to 20 carbon atoms, preferably having from 1 to 5 carbon atoms in the alkoxide group such as, for example ethoxide, butoxide and isopropoxide. Non-limiting examples of metal salts include, but are not limited to, at least one of the salts (i.e., metal nitrates, metal chloride, acetates, acetylacetonates, nitrites) of Ag, Pd or Ru. In the case of Pd, cationic salts such as the amine chlorides can be used for the exchange species.

Typically, the components of the catalytically active component precursors are present on a nanoscale level. For example, TiO₂ is present as anatase particles measuring about 1 to about 10 nanometers in diameter using transmission electron spectroscopy.

The catalytically active component may be homogenously or non-homogeneously dispersed within the ion exchange membrane or placed on the gas diffusion backing. The catalytically active component may be further homogeneously or non-homogeneously dispersed on the surface of the ion exchange membrane or in an electrocatalyst composition.

The amount of catalytically active component precursors utilized is dependent upon the method in which it is employed, whether it is dispersed within the membrane or on the gas diffusion backing, and whether it is further coated onto the surface of the membrane or contained in the catalyst coating that is applied to the membrane.

In general, the catalytically active component precursors may be formed according to those methods well known in the art and are commercially available. However, as noted above, the present invention further contemplates the preparation of the alkoxides and mixtures thereof, which must be performed according to a specific process. A combination of processes, e.g., formation of oxides via alkoxide precursors (of Ti, Zr and Nb) as well as the introduction of cationic and inorganic salts (of Ag, Pd or Ru) followed by chemical reduction, can be used.

Typically, the catalytically active components of the present invention comprise from about 0.01 wt-% to about 25 wt-% of the total weight of the membrane and the metal component, preferably from about 0.01 wt-% to about 10 wt-%, more preferably from about 0.01 wt-% to about 5 wt-% and most preferably from about 0.01 wt-% to about 2 wt-%.

A process for incorporating into a perfluorosulfonic acid ion exchange membrane at least one alkoxide comprising:
(i) preparing a perfluorosulfonic acid ion exchange membrane by extracting water from the ion exchange membrane (especially when the precursor alkoxide is titanium ethoxide);
(ii) optionally drying the ion exchange membrane;
(iii) imbibing the ion exchange membrane with the at least one alkoxide; and
(iv) hydrolysis in air.

Preferably, the removal of water from the membrane occurs by directly first soxhlet extracting water from the ion exchange membrane with ethanol. In the case of titanium ethoxide precursors, this method is superior to the incorporation of TiO₂ by other methods (in which the membrane is first heated or freeze-dried prior to the introduction of the titanium alkoxide (see comparative Examples B and C).

For alkoxides which hydrolyze more slowly, such as titanium (IV) n-butoxide, the Nafion® membrane or other ion exchange membrane can be optionally dried and imbibed with the alkoxide followed by slow hydrolysis in air (see Example 5).

Impregnation of a Membrane with at Least One Catalytically Active Component

The catalytically active component precursors can be added directly to the PEM by several synthetic processes known in the art such as, for example (i) cationic ionic exchange followed by chemical reduction to fully or partially regenerate the acid sites in the PEM (as set forth in Examples 1, 2, 3, 6, 7, 8 and 9); (ii) direct imbibement of a reactive alkoxide followed by hydrolysis to form catalytically active oxides (as set forth in Examples 4 and 5); or (iii) casting or extruding PEM's with the catalytically active component precursors. Hydrogen peroxide scavengers that are directly added to the PEM ion exchange membrane are preferentially located far enough away from the sites of attack so that they decompose the hydrogen peroxide possibly to short lived radicals which can then quickly generate H₂O and O₂ before intercepting the “susceptible” parts of the PEM.

Hydrogen peroxide scavengers that are directly added to the ion exchange membrane may be added during solution casting of ionomer solutions. The catalytically active components can be added as particulate powders (e.g. nanoscale powders of TiO₂, Nb₂O₅ and ZrO₂) to the solution containing, for instance, the perfluorinated sulfonic acid polymers (PFSA) used to cast Nafion® membranes. If a non-aqueous solution is used for the casting process, an alkoxide species of titanium, niobium and zirconium can be added and allowed to slowly react with air as the film is cast and dries. Alternatively, the catalytically active components can be added as particulate powders (e.g. nanoscale powders of TiO₂, Nb₂O₅ and ZrO₂) to the perfluorinated polymer used to extrude the proton exchange membranes.

Inorganic salts of silver, palladium and ruthenium such as the cationic salts described herein can be added to polar solutions of these ionomers. After casting to form the PEM, they can be fully or partially reduced to form the catalytically active component within the cast membrane.

Typically, the catalytically active components of the present invention comprise from about 0.01 wt-% to about 25 wt-% of the total weight of the membrane and the metal component, preferably from about 0.01 wt-% to about 10 wt-%, more preferably from about 0.01 wt-% to about 5 wt-% and most preferably from about 0.01 wt-% to about 2 wt-%.

The stability imparted by impregnation of the PEM (preferably perfluorinated sulfonic acid membranes) with the catalytically active components can be measured ex-situ by the action of H₂O₂ on the membrane in the presence of Fe²+ catalyst. Stability of the metallized membrane can also be measured in a fuel cell under accelerated decay conditions. The decomposition of the membrane can be determined by measuring the amount of hydrogen fluoride that is released during the reaction with hydrogen peroxide radicals in the ex-situ H₂O₂ test or in fuel cell tests.

### Surface Coating of Catalytically Active Components

Catalytically active component precursors can be coated onto the surface of the PEM; applied to the surface of a membrane prior to the application of an electrocatalyst; contained within the electrocatalyst layer; or applied to the gas diffusion backing using those methods known within the art for the application of such coatings, for example typical ink technology for the application of an electrocatalyst layer to a membrane; techniques such as sputtering and vapor deposition as well as any other conventional method known within the art.

The surface layer containing the catalytically active components generally has a thickness up to about 50 microns, preferably about 0.01 to about 50 microns, more preferably about 10-20 microns and most preferably about 10-15 microns.

Where the catalytically active component is applied to the gas diffusion backing, an appropriate application method can be used, such as spraying, dipping or coating. The catalytically active component can also be incorporated in a “carbon ink” (carbon black and electrolyte) that may be used to pretreat the surface of the GDB that contacts the electrode surface of the membrane. The catalytically active component can also be added to the PTFE dispersion that is frequently applied to the GDB to impart hydrophobicity to the GDB. The intent is that the catalytically active component will leach out of the GDB coating during normal fuel cell operation, and into the membrane where it will be effective in reducing hydrogen peroxide attack on the reactive polymer endgroups of the membrane.

Typically, the catalytically active component of the present invention found on the surface of the membrane comprise from about 0.01 wt-% to about 25 wt-% of the total weight of the membrane and the metal component, preferably from about 0.01 wt-% to about 10 wt-%, more preferably from about 0.01 wt-% to about 5 wt-% and most preferably from about 0.01 wt-% to about 2 wt-%.

Typically, a liquid medium or carrier is utilized to deliver the precursors. Generally, the liquid medium is also compatible with the process for creating the gas diffusion electrode (GDE) or catalyst coated membrane (CCM), or for coating the electrocatalyst onto the membrane or gas diffusion backing (GDB). It is advantageous for the medium to have a sufficiently low boiling point that rapid drying is possible under the process conditions employed, provided however, that the medium does not dry so fast that the medium dries before transfer to the membrane. When flammable constituents are to be employed, the medium can be selected to minimize process risks associated with such constituents. The medium also must be sufficiently stable in the presence of the ion exchange polymer, which has strong acidic activity in the acid form. The liquid medium typically includes polar components for compatibility with the ion exchange polymer, and is preferably able to wet the membrane. Depending on the specific application technique and fabrication conditions, it is possible for water to be used exclusively as the liquid medium.

A wide variety of polar organic liquids or mixtures thereof can serve as suitable liquid media for coatings applied directly to the membrane. Water can be present in the medium if it does not interfere with the coating process. Although some polar organic liquids can swell the membrane when present in sufficiently large quantity, the amount of liquid used is preferably small enough that the adverse effects from swelling during the process are minor or undetectable. It is believed that solvents able to swell the ion exchange membrane can provide better contact and more secure application of the electrode to the membrane. A variety of alcohols are well suited for use as the liquid medium.

Typical liquid media include suitable C₄ to C₈ alkyl alcohols such as n-, iso-, sec- and tert-butyl alcohols; the isomeric 5-carbon alcohols such as 1,2- and 3-pentanol, 2-methyl-1-butanol, 3-methyl, 1-butanol, etc.; the isomeric 6-carbon alcohols, such as 1-, 2-, and 3-hexanol, 2-methyl-1-pentanol, 3-methyl-1-pentanol, 2-methyl-1-pentanol, 3-methyl, 1-pentanol, 4-methyl-1-pentanol, etc.; the isomeric C₇ alcohols and the isomeric C₈ alcohols. Cyclic alcohols are also suitable. Preferred alcohols are n-butanol and n-hexanol, and n-hexanol is more preferred.

The catalytically active component precursors may also be applied to the surface of the PEM by their addition to the anode or cathode electrocatalyst layers in the membrane electrode assembly. Typically, the catalytically active components of the present invention found on the surface of the membrane comprise from about 0.01 wt-% to about 25 wt-% of the total weight of the membrane and the metal component, preferably from about 0.01 wt-% to about 10 wt-%, more preferably from about 0.01 wt-% to about 5 wt-% and most preferably from about 0.01 wt-% to about 2 wt-%.

Such electrocatalyst layers may be applied directly to the ion exchange membrane, or alternatively, applied to a gas diffusion backing, thereby forming a catalyst coated membrane (CCM) or gas diffusion electrode (GDE) respectively.

A variety of techniques are known for CCM manufacture. Typical methods for applying the electrocatalyst onto the gas diffusion backing or membrane include spraying, painting, patch coating and screen, decal, pad printing or flexographic printing.

The gas diffusion backing comprises a porous, conductive sheet material in the form of a carbon paper, cloth or composite structure, that can optionally be treated to exhibit hydrophilic or hydrophobic behavior, and coated on one or both surfaces with a gas diffusion layer, typically comprising a layer of particles and a binder, for example, fluoropolymers such as PTFE. The electrocatalyst coating composition can be coated onto the gas diffusion backing. Those gas diffusion backings in accordance with the present invention as well as the methods for making the gas diffusion backings are those conventional gas diffusion backings and methods known to those skilled in the art. Suitable gas diffusion backings are commercially available, for example, Zoltek® carbon cloth (available from Zoltek Companies, St. Louis Mo.); ELAT® (available from E-TEK Incorporated, Natick Mass.); and Carbel® (available from W. L. Gore and Associates, Newark Del.) a plastic in the form of sheets for use in manufacturing, namely plastic elements for gas diffusion applications.

Known electrocatalyst coating techniques can be used and will produce a wide variety of applied layers of essentially any thickness ranging from very thick, e.g., 30 μm or more to very thin, e.g., 1 μm or less. The applied layer thickness is dependent upon compositional factors as well as the process utilized to generate the layer. The compositional factors include the metal loading on the coated substrate, the void fraction (porosity) of the layer, the amount of polymer/ionomer used, the density of the polymer/ionomer, and the density of the support. The process used to generate the layer (e.g. a hot pressing process versus a painted on coating or drying conditions) can affect the porosity and thus the thickness of the layer.

As noted above for measuring the stability of a metal-impregnated membrane, the stability imparted by surface-coating the PEM (preferably perfluorinated sulfonic acid membrane) with catalytically active components can be measured ex-situ by the action of H₂O₂ on the membrane in the presence of Fe²+ catalyst. Stability of the surface-coated membrane can also be measured in a fuel cell under accelerated decay conditions. The decomposition of the membrane can be determined by measuring the amount of hydrogen fluoride that is released during the reaction with hydrogen peroxide radicals in the ex-situ H₂O₂ test or in fuel cell tests.

### Proton Exchange Membrane

The proton exchange membrane of the present invention is comprised of a perfluorosulfonic acid ion exchange polymer. Such polymers are highly fluorinated ion-exchange polymers, meaning that at least 90% of the total number of univalent atoms in the polymer are fluorine atoms. Most typically, the ion exchange membrane is made from perfluorosulfonic acid (PFSA)/tetrafluoroethylene (TFE) copolymer by E. I. duPont de Nemours and Company, and sold under the trademark Nafion®. It is typical for polymers used in fuel cells to have sulfonate ion exchange groups. The term “sulfonate ion exchange groups” as used herein means either sulfonic acid groups or salts of sulfonic acid groups, typically alkali metal or ammonium salts. For fuel cell applications where the polymer is to be used for proton exchange such as in fuel cells, the sulfonic acid form. If the polymer comprising the membrane is not in sulfonic acid form when used the membrane is formed, a post treatment acid exchange step can be used to convert the polymer to acid form. As noted above, suitable perfluorinated sulfonic acid polymer membranes in acid form are available under the trademark Nafion® by E. I. du Pont de Nemours and Company.

Reinforced perfluorinated ion exchange polymer membranes can also be utilized in manufacture of the membrane. Reinforced membranes can be made by impregnating porous, expanded PTFE (ePTFE) with ion exchange polymer. ePTFE is available under the trade name “Gore-Tex” from W. L. Gore and Associates, Inc., Elkton, Md., and under the trade name “Tetratex” from Tetratec, Feasterville, Pa. Impregnation of ePTFE with perfluorinated sulfonic acid polymer is disclosed in U.S. Pat. Nos. 5,547,551 and 6,110,333.

Alternately, the ion exchange membrane can include a porous support. A porous support may improve mechanical properties for some applications and/or decrease costs. The porous support can be made from a wide range of components, including hydrocarbons and polyolefins (e.g., polyethylene, polypropylene, polybutylene, copolymers of these matrials including polyolefins, and the like) and porous ceramic substrates.

The ion exchange membrane for use in accordance with the present invention can be made by extrusion or casting techniques and have thicknesses that can vary depending upon the intended application, ranging from 127 microns to less than 25.4 microns. The preferred membranes used in fuel cell applications have a thickness of about 5 mils (about 127 microns) or less, preferably about 2 mils (about 50.8 microns) or less, although recently membranes that are quite thin, i.e., 25 μm or less, are being employed.

### EXAMPLES

The embodiments of the present invention are further defined in the following Examples. It should be understood that these Examples are given by way of illustration only. From the above discussion and these Examples, one skilled in the art can ascertain the essential characteristics of this invention, and without departing from the spirit and scope thereof, can make various changes and modifications of the invention to adapt it to various uses and conditions. Thus various modifications of the present invention in addition to those shown and described herein will be apparent to those skilled in the art from the foregoing description. Although the invention has been described with reference to particular means, materials and embodiments, it is to be understood that the invention is not limited to the particulars disclosed, and extends to all equivalents within the scope of the claims.

Durability of metallized Nafion® membrane was measured under accelerated decay conditions, wherein the PEM was exposed to a chemically degrading environment. The effect of impregnation of the PEM membrane (Nafion®) by metal catalysts was measured ex-situ by the action of H₂O₂ on the Nafion® membrane in the presence of Fe²⁺ catalyst. The decomposition of the membrane was determined by measuring the amount of hydrogen fluoride that is released from the membrane during the reaction with hydrogen peroxide radicals. In the ex-situ peroxide test, the concentration of iron(II) sulfate was constant; however, the membrane samples were either 0.5 g or 1.0 g. The greater weight percent of iron is absorbed into the 0.5 g Nafion® control sample A1, which explains the higher fluoride release compared with the 1.0 g control sample A2.

Likewise, TiO₂ prepared in accordance with Comparative Examples B and C have a negligible effect on the decomposition of the membrane, however suppressed decomposition when prepared according to the present invention.

Accelerated fuel cell tests were also performed. The fuel cell used was made by Fuel Cell Technologies (Albuquerque, N. Mex.): Its area was 25 cm² cell with Pocco graphite flow fields. The cell was assembled and then conditioned for 10 hours at 80° C. and 25 psig (170 kPa) back pressure with 100% relative humidity hydrogen and air being fed to the anode and cathode, respectively. The gas flow rate was two times stoichiometry, that is, hydrogen and air were fed to the cell at twice the rate of theoretical consumption at the cell operating conditions. During the conditioning process the cell was cycled between a set potential of 200 mV for 10 minutes and the open circuit voltage for 0.5 minutes, for a period of 3 hours. Then, the cell was kept at 400 mA/cm² for 1 hour. Next, two polarization curves were taken, starting with the current density at 1200 mA/cm² and then stepping down in 200 mA/cm2 decrements to 100 mA/cm², recording the steady state voltage at each step. After conditioning, the cell was tested for performance at 65° C. and atmospheric pressure with 90% relative humidity hydrogen and oxygen. Hydrogen was supplied to the anode at a flow rate equal to 1.25 stoichiometry. Filtered compressed air was supplied to the cathode at a flow rate to supply oxygen at 1.67 times stoichiometry. Two polarization curves were taken, starting with the current density at 1000 mA/cm², and then stepping down in 200 mA/cm² decrements to 100 mA/cm², recording the steady state voltage at each step. This was followed by an accelerated decay test at 90° C. cell temperature and 30% relative humidity on the anode and cathode with hydrogen and pure oxygen gases. The test was done with no load on the cell and the open circuit voltage of the cell was monitored over a period of 48 hrs. During this 48 hr time period, the water from the anode and cathode vent lines of the cell were collected and analyzed for the presence of any fluoride ions (that would be generated by possible chemical degradation of the membrane and/or the ionomer in the catalyst layers). The cell, if it survived the decay test (i.e., if the open circuit voltage stayed above 0.8V with no sudden drop during the decay test), was further characterized by the performance test described above at 65° C. cell temperature.

### Example 1

### Ag/Nafion® Membrane

A 12.07 cm×12.07 cm sample of Nafion® 112 membrane (50.8 microns thick) was imbibed with a solution containing 1 g of silver nitrate (AgNO₃, available from EM Sciences, SX0205-5) dissolved in 200 mL of water. After allowing the silver salt to penetrate and exchange into the Nafion® membrane for 72 hours, the solution was decanted and the membrane was rinsed with water.

In a second step, a 50% solution of hypophosphorous acid was added to the membrane and allowed to completely cover it. The Ag/Nafion® membrane was allowed to react with the hypophosphorous acid for approximately 12 hours, after which the solution was decanted and the membrane rinsed with water.

### Example 2

### Pd/Nafion® Membrane H₃PO₂ Reduction

A 7 cm×7 cm sample of Nafion® 112 membrane was contacted with 30 mL of a solution containing 1 g of the cationic salt tetramine palladium (II) chloride (available from Alfa, 11036, Pd(NH₃)₄Cl₂) dissolved in 200 mL of H₂O. The palladium salt solution was allowed to contact the Nafion® membrane for approximately 12 hours at room temperature. The excess solution was decanted and the membrane was rinsed with water.

In a second reaction step, a 50 wt % H₃PO₂ solution was added to the membrane. The Nafion® membrane was allowed to react with the hypophosphorous acid overnight, after which the solution was decanted and the membrane rinsed.

### Example 3

### Pd/Nafion® Membrane, Hydrazine Reduction

The same procedure was used as that described in Example 2, except that instead of hypophosphorous acid, 10 mL of a 35% hydrazine solution, (available from Aldrich, 30,940-0, 35 wt % in H₂O) diluted with an additional 150 mL of H₂O, was used to reduce the palladium.

### Example 4

### Ti/Nafion® Membrane (Imbibition Followed by Slow Hydrolysis)

A 5 inch×5 inch piece of Nafion® 112 membrane was exchanged punctiliously in a soxhlet extractor. The extraction of water from the membrane was performed over a period of 6 hours.

This membrane was transferred into a “dry bag” which was purged with nitrogen gas. Under flowing nitrogen, 50 mL of titanium (IV) ethoxide (available from Aldrich, #24, 475-9, contains 20 wt % Ti) was allowed to soak into the membrane for a period of 12 hours.

The excess solution was then decanted, and the bag was opened. The Ti/Nafion® membrane was allowed to react slowly with moisture in the air.

### Example 5

A 5″×5″ sample of Nafion® 112 membrane was placed inside of a plastic bag which was purged with nitrogen. To this bag, approximately 50 ml of titanium (IV) n-butoxide (available from Aldrich, #24, 411-2) was added, and the material was allowed to soak into the membrane for 12 hours. The alkoxide solution was subsequently decanted off and the membrane was exposed to air and allowed to react for several days to form the final material.

### Example 6

A 7 cm×7 cm piece of Nafion® 112 membrane was soaked with 30 mL of a solution derived from dissolving 1.0 g of hexamine ruthenium (III) chloride (available from Alfa, 10511, Ru 32.6 wt %, Ru(NH₃)₆Cl₃) in 200 mL of H₂O.

In a second reaction step, a 50 wt % H₃PO₂ solution was added to the membrane. The Nafion® membrane was allowed to react with the hypophosphorous acid overnight, after which the solution was decanted and the membrane rinsed.

### Example 7

The same procedure was used as described in Example 6. However, instead of hypophosphorus acid, 10 ml of a 35% hydrazine/H₂O solution was diluted with 150 ml H₂O. The ion exchanged membrane was added to the beaker and allowed to soak in the solution for 12 hours. The membrane was subsequently removed from the solution and rinsed with water prior to use.

### Comparative Example A1

A control Nafion® 112 membrane, where the membrane sample weighed 0.5 gram.

### Comparative Example A2

A control Nafion® 112 membrane, where the membrane sample weighed 1.0 gram.

### Comparative Example B

A 5 inch×5 inch square of Nafion® 112 membrane was heated in an oven at 115° C. for 40 minutes. The dried membrane was then transferred to an inert atmosphere glove bag (with N₂ gas). 50 mL of titanium ethoxide (Aldrich, 24-475-9, contains approximately 20% Ti) was contacted with the membrane under N₂ overnight. The excess solution was decanted and the membrane was allowed to slowly react with water in the air.

### Comparative Example C

A 5 inch×5 inch piece of Nafion® 112 membrane was freeze dried over a period of 72 hours. The freeze dried membrane was placed in an inert atmosphere glove bag (with nitrogen gas) and the membrane was allowed to contact 50 mL of titanium (IV) ethoxide (Aldrich, 24, 475-9) for approximately 12 hours. The excess reagent was decanted from the membrane, which was subsequently allowed to react with moisture in the air to hydrolyze the alkoxide.

### Example 8

### Fuel Cell Test

The same procedure was used for the preparation of the Nafion® 112 membrane as described in Example 1, wherein the membrane was subsequently inserted into a fuel cell.

### Example 9

### Fuel Cell Test

Two 4.5×6″ samples of Nafion® 112 membrane were contacted with 30 ml of a solution containing 1 g of the tetramine palladium (II) palladium salt. The solution was allowed to contact the membrane for 72 hours. One of these membrane samples was removed, rinsed with water, and placed in a flat, 190×100 mm Petri dish. It was then contacted and immersed in 30-35 ml of a 35% solution of hydrazine (which had been diluted with 450 ml of water). A second reduction (identical to the first) was performed after 12 hours. The material was then washed and heated in water at 90° C. to rehydrate the membrane for the fuel cell test.

### Comparative Example D

### Fuel Cell Test

A Nafion® 112 membrane was inserted into a fuel cell, wherein the membrane was used as a control sample.

### Procedure for Hydrogen Peroxide Stability Test

To a 25 mm×200 mm test tube was added 0.5 g or 1.0 g piece of dried (1 hour at 90° C. in Vac oven) metallized Nafion® membrane. To this was added a solution of 50 mL of 3% hydrogen peroxide and 1 mL of iron sulfate solution (FeSO₄*7H₂O)(0.006 g in 10 mL H₂O). A stir bar was placed on top to keep the membrane immersed in solution. The sample tube was slowly immersed in a hot water bath (85° C.) and heated for 18 hours. The sample was removed, and when cooled the liquid was decanted from the test tube into a tared 400 mL beaker. The tube and membrane were rinsed with deionized water, and the rinses were placed in the beaker. Two drops of Phenolphthalein were added, and the contents of the beaker were titrated with 0.1 N NaOH until the solution turned pink. The beaker was weighed. A mixture of 10 mL of the titrated solution and 10 mL of sodium acetate buffer solution was diluted with deionized H₂O to 25 mL in a volumetric flask. The conductivity was recorded using an fluoride ion selective electrode and the amount of fluoride (in ppm) was determined from a “ppm vs. mV” calibration curve. The experiment was repeated two more times on the same piece of membrane.

TABLE 1
Ex-situ measurement of the action of H₂O₂ on an impregnated
PEM membrane in the presence of Fe² + catalyst

| | Measured | | | | | |
|---|---|---|---|---|---|---|
| Example | Comp. | Pre- | Reduction | Sample | mg F−/g | |
| (Metal System) | (wt %) | treatment | Method | Size (g) | sample | μmol F−/g/hr |
| Example 1(Ag) | 0.072 | | HYPO | 0.5 | 0.3624 | 3.532E−04 |
| Example 2(Pd) | | | HYPO | 0.5 | 0.0950 | 9.259E−05 |
| Example 3(Pd) | | | Hydrazine | 0.5 | 0.0878 | 8.558E−05 |
| Example 4(Ti) | 1.052 | EtOH soxhlet | | 1.0 | 0.0945 | 9.210E−05 |
| | | extracted | | | | |
| Example 5 (Ti) | 1.099 | | | 0.5 | 0.0209 | 2.040E−05 |
| Example 6 (Ru) | | | HYPO | 0.5 | 0.0911 | 8.879E−05 |
| Example 7 (Ru) | | | Hydrazine | 0.5 | 0.0854 | 8.324E−05 |
| Comp. Ex. A1 | | | | 0.5 | 20.95 | 2.042E−02 |
| Comp. Ex. A2 | | | | 1.0 | 9.890 | 9.642E−03 |
| Comp. Ex. B (Ti) | 1.008 | Heat Treated | | 1.0 | 5.311 | 5.176E−03 |
| Comp. Ex. C (Ti) | 1.300 | Freeze-dried | | 1.0 | 4.175 | 4.069E−03 |

In the above Table 1, the designation HYPO represents hypophosphorous acid as the reducing agent.

TABLE 2
Accelerated Fuel Cell Test Results

| | Anode Fluoride Emission | Cathode Fluoride Emission |
|---|---|---|
| Example | Rate (micromoles | Rate (micromoles |
| (Metal System) | fluoride/cm²/hr) | fluoride/cm²/hr) |
| Example 8 (Ag) | 0.022 | 0.073 |
| Example 9 (Pd) | 0.152 | 0.185 |
| Comp. Ex D | 0.480 | 0.504 |
| (control) | | |

What is claimed is:

1. A method for increasing peroxide radical resistance in a fuel cell perfluorosulfonic acid ion exchange membrane, comprising:
a) forming a perfluorosulfonic acid ion exchange membrane with a catalytically active component therein, said membrane having a thickness of about 127 microns or less;
b) fabricating said membrane into a membrane electrode assembly and incorporating said assembly into a fuel cell;
c) operating the fuel cell wherein at least one hydrogen peroxide molecule is generated;
d) contacting the at least one hydrogen peroxide molecule with said catalytically active component; and
e) decomposing the hydrogen peroxide molecule to form water and oxygen.

2. The method according to claim 1, wherein the fuel cell further comprises a gas diffusion backing positioned on at least one side of said membrane, said gas diffusion backing having at least one catalytically active component on a surface of the gas diffusion backing.

3. The method according to claim 1, wherein the membrane has a thickness of about 51 microns or less.

4. The method according to claim 1, wherein the at least one catalytically active component comprises about 0.01 wt-% to about 25 wt-% of the total weight of the membrane and catalytically active component.

5. The method according to claim 4, wherein the at least one catalytically active component comprises about 0.01 wt-% to about 10 wt-% of the total weight of the membrane and catalytically active component.

6. The method according to claim 5, wherein at least one catalytically active component comprises about 0.01 wt-% to about 5 wt-% of the total weight of the membrane and catalytically active component.

7. The method according to claim 6, wherein at least one catalytically active component comprises about 0.01 wt-% to about 2 wt-% of the total weight of the membrane and catalytically active component.

8. The method according to claim 1, wherein the catalytically active component comprises at least one metal, metal salt, or combinations thereof, wherein the catalytically active component has been partly or completely reduced using a reduction agent.

9. The method according to claim 8, wherein the metal is at least one of Ag, Pd or Ru.

10. The method according to claim 8, wherein the metal salt comprises at least one salt of Ag, Ru or Pd.

11. The method according to claim 8, wherein the reducing agent is hydrazine, hydroxylamine, borohydride, hydrogen gas or hypophosphorous acid.

12. The method according to claim 1, wherein the catalytically active component comprises at least one metal oxide.

13. The method according to claim 12, wherein the metal oxide comprises at least one of titanium oxide, Ti—O containing complex, zirconium oxide, Zr—O containing complex, niobium oxide, Nb—O containing complex, ruthenium oxide, or Ru—O containing complex.

14. The method according to claim 1, wherein the perfluorosulfonic acid ion exchange membrane is a fluoropolymer reinforced perfluorosulfonic acid membrane or a perfluorosulfonic acid membrane reinforced with a porous support substrate.

15. The method according to claim 14, wherein the porous support substrate is expanded PTFE, ultra-high molecular weight hydrocarbon, or a porous ceramic structure.

16. The method of claim 1 wherein the perfluorosulfonic acid ion exchange membrane is formed by forming a mixture of a dispersion of perfluorosulfonic acid polymer and the catalytically active component or a precursor thereof, and casting the membrane from said mixture.

17. The method of claim 1 wherein the perfluorosulfonic acid ion exchange membrane is formed by forming a mixture of perfluorosulfonic acid polymer and the catalytically active component or a precursor thereof, and extruding the membrane from said mixture.

18. The method of claim 1 wherein the perfluorosulfonic acid ion exchange membrane is formed by casting or extruding the membrane from a perfluorosulfonic acid polymer, imbibing the membrane with a reactive alkoxide, and hydrolyzing the reactive alkoxide to form a catalytically active oxide in the membrane.

19. A process for incorporating into a perfluorosulfonic acid ion exchange membrane with an at least one alkoxide comprising:
(i) preparing a perfluorosulfonic acid ion exchange membrane by extracting water from the ion exchange membrane;
(ii) optionally drying the ion exchange membrane;
(iii) imbibing the ion exchange membrane with the at least one alkoxide; and
(iv) hydrolysis in air.

20. The process according to claim 19, wherein water is extracted by directly first soxhlet using ethanol when the at least one alkoxide is titanium ethoxide.

21. A method for increasing peroxide radical resistance in a fuel cell perfluorosulfonic acid ion exchange membrane, comprising:
a) forming a perfluorosulfonic acid ion exchange membrane having a thickness of about 127 microns or less;
b) positioning a gas diffusion backing on at least one side of the ion exchange membrane, said gas diffusion backing having a surface with a catalytically active component affixed thereto;
c) fabricating said membrane and gas diffusion backing into a membrane electrode assembly; and
d) incorporating said assembly into a fuel cell;
e) operating the fuel cell so as to effect leaching of catalytically active component into the membrane;
f) generating at least one hydrogen peroxide molecule in the fuel cell;
g) contacting the at least one hydrogen peroxide molecule with said catalytically active component; and
h) decomposing the hydrogen peroxide molecule to form water and oxygen.

22. The method according to claim 21, wherein the catalytically active component comprises at least one metal, metal salt, or combinations thereof, wherein the catalytically active component has been partially or wholly reduced using a reduction agent.

23. The method according to claim 22, wherein the metal is at least one of Ag, Pd or Ru.

24. The method according to claim 22, wherein the metal salt comprises at least one salt of Ag, Ru or Pd.

25. The method according to claim 22, wherein the reducing agent is hydrazine, hydroxylamine, borohydride, hydrogen gas or hypophosphorous acid.

26. The method according to claim 21, wherein the catalytically active component comprises at least one metal oxide.

27. The method according to claim 26, wherein the metal oxide comprises at least one of titanium oxide, Ti—O containing complex, zirconium oxide, Zr—O containing complex, niobium oxide, Nb—O containing complex, ruthenium oxide, or Ru—O containing complex.
